(19) United States
(12) Patent Application Publication
(10) Pub. No.: US 2020/0092591 A1
(43) Pub. Date: Mar. 19, 2020

(54) METHOD FOR TRANSMITTING AN IMMERSIVE VIDEO

(71) Applicant: SAGEMCOM BROADBAND SAS, Rueil Malmaison (FR)

(72) Inventors: Pierre SABATIER, Rueil Malmaison (FR); Jèrôme BERGER, Rueil Malmaison (FR)

(73) Assignee: SAGEMCOM BROADBAND SAS, Rueil Malmaison (FR)

(21) Appl. No.: 16/617,887

(22) PCT Filed: Jun. 5, 2018
(86) PCT No.: PCT/EP2018/064706

§ 371 Date: Nov. 27, 2019

(30) Foreign Application Priority Data
Jun. 6, 2017 (FR) 1755017

(51) Int. Cl. H04N 21/2343; H04N 19/176; H04N 19/597; H04N 19/167; H04N 13/194; H04N 13/366; H04N 13/332; H04N 21/231; H04N 21/81; H04N 21/2662

(52) U.S. Cl. CPC H04N 21/234309; H04N 19/176; H04N 19/597; H04N 19/167; H04N 13/194; H04N 21/2662; H04N 13/332; H04N 21/231; H04N 21/816; H04N 21/234363; H04N 13/366

(57) ABSTRACT

A method for transmitting an immersive video between a network unit and an item of viewing equipment enables users to simultaneously view the immersive video which has a series of sets of images each composed of blocks of pixels. The immersive video is transmitted in a compressed form to each item of viewing equipment. For each set of images: information is obtained representing a point of view on the immersive video of each user; at least one privileged zone is determined corresponding to at least some of the points of view; for each image included in the set of images, a higher compression rate on average than a mean of the compression rates applied to the blocks of pixels belonging to a privileged zone is applied to the blocks of pixels not belonging to a privileged zone; and the set of images is transmitted to each item of viewing equipment.

The present invention relates to a method for transmitting an immersive video to a plurality of users, and a system and device able to implement the method.

The past years have seen a plurality of image and video viewing modes appear. Thus, whereas until the years 2000 there were merely two-dimensional (2D) images, stereoscopic videos, videos in three dimensions (3D) and immersive videos depicting the same scene taken in a plurality of points of view, for example at 360 degrees, have appeared.

At the present time, systems for broadcasting immersive videos no longer require the use of dedicated rooms comprising a 360 degrees screen and a plurality of image-projection devices each projecting a point of view of an immersive video. It is in fact possible now to obtain a system for broadcasting immersive videos using glasses, referred to as immersive glasses or immersive 3D glasses, comprising an integrated image-display device.

This simpler method of use makes it possible to envisage that systems for broadcasting immersive videos will be within the use of everyone. Thus, in future, users will be able to display immersive videos in their home. These immersive videos will be supplied for example by operators and transmitted through communication networks such as the internet, like what takes place currently with the broadcasting of 2D videos by internet.

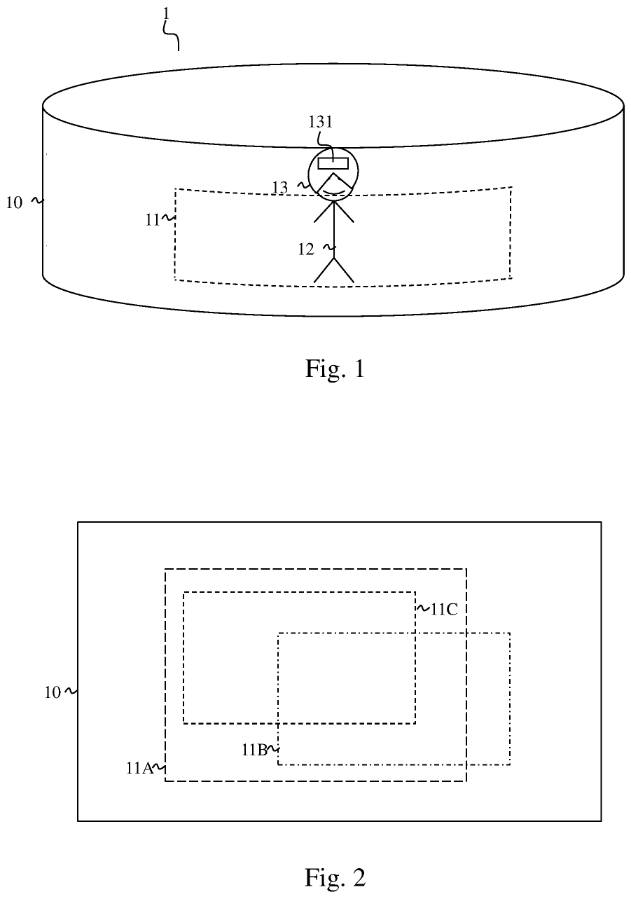

FIG. 1 illustrates schematically an example of a system for broadcasting immersive videos 1. In this system, a user 12 wears a pair of immersive glasses 13. This pair of immersive glasses 13 comprises a processing module 131 and an image-viewing module, not shown. The image-viewing module comprises for example a screen facing each eye of the user 12. The image-viewing module enables the user to view a 360 degrees video represented by a ring 10 in FIG. 1. In this system, the immersive video has been received by the processing module 131 of a server by means of a communication network, and then decoded by the processing module 131 before display thereof on the image viewing module.

During the display, the system for broadcasting immersive videos 1 defines a simple geometric shape (here a ring, but other shapes are possible, such as a sphere, a dome or a cube) to which the immersive video is applied. However, the user 12 sees only part of the immersive video limited by his field of view. Thus, in FIG. 1, the user 12 sees only a spatial subpart 11 of the immersive video facing him. The rest of the immersive video is used only if the user 12 changes point of view on the video.

In addition to offering a point of view to the user that is much broader than a conventional HD (high definition: 1920×1080 pixels) video, an immersive video generally has a spatial resolution and a temporal resolution that are appreciably superior to a conventional HD video. Such characteristics involve a very high bitrate, which may be difficult for the network to support.

In some immersive video broadcasting systems, the user receives the immersive video in full spatial and temporal resolution. The communication network must therefore support a relatively high bitrate. This bitrate is all the greater since a plurality of users may receive the same immersive video at the same time. In order to overcome this problem of bitrate, in other immersive video broadcasting systems each user receives only a spatial subpart of the immersive video corresponding to his point of view. However, problems of latency are posed in this type of system as soon as a user changes point of view on the immersive video. This is because, when a user changes point of view, he must inform the server that he has changed point of view, and the server must respond by transmitting to the user a spatial subpart of the video corresponding to the new point of view.

It is desirable to overcome these drawbacks of the prior art. It is in particular desirable to provide a system that is reactive when point of view is changed on an inmersive video and economical in terms transmission rate of said immersive video when a plurality of users are viewing said video.

It is in addition desirable to provide a solution that is simple to implement at low cost.

According to a first aspect of the present invention, the present invention relates to a method for transmitting an immersive video between a network unit and at least one item of viewing equipment enabling a plurality of users to view said immersive video simultaneously, the network unit and each item of viewing equipment being connected by a communication network, the immersive video comprising a series of sets of images, each image being composed of blocks of pixels, the immersive video being transmitted in encoded form according to a predetermined video compression standard to each item of viewing equipment. The method is implemented by the network unit and comprises, for each set of images: obtaining information representing a point of view on the immersive video observed by each user; determining at least one image zone, referred to as the privileged zone, corresponding to at least some of the points of view; for each image included in the set of images, applying to the blocks of pixels not belonging to a privileged zone a compression rate on average higher than a mean of the compression rates applied to the blocks of pixels belonging to a privileged zone, and transmitting the set of images to each item of viewing equipment.

In this way, the bitrate of the immersive video is reduced compared with an immersive video transmitted at full quality whatever the points of view since the zones of the images situated outside the privileged zone correspond to a zone of the immersive video observed by a majority of users are encoded in a lower quality.

According to one embodiment, the network unit obtains the immersive video in a non-compressed form and encodes the immersive video according to the predetermined video compression standard, or the network unit obtains the immersive video in a compressed form and transcodes the immersive video so that it is compatible with the predetermined video compression standard.

According to one embodiment, the method comprises: determining, for each point of view, a spatial subpart of the immersive video corresponding to said point of view; determining a centre for each spatial subpart; determining a barycentre of at least some of the centres of the spatial subparts; and defining a rectangular zone centred on the barycentre, said rectangular zone forming a privileged zone, the rectangular zone having dimensions that are predefined or determined according to an available bitrate on the communication network.

According to one embodiment, the method comprises: determining, for each point of view, a spatial subpart of the immersive video corresponding to said point of view; determining at least one union of the spatial subparts overlapping; and, for each group of spatial subparts resulting from a union, defining a rectangular zone encompassing said group of spatial subparts, each rectangular zone forming a privileged zone.

According to one embodiment, the method comprises: determining, for each point of view, a spatial subpart of the immersive video corresponding to said point of view; defining a plurality of categories of blocks of pixels, a first category comprising blocks of pixels not appearing in any spatial subpart, and at least one second category comprising blocks of pixels appearing at least in a predefined number of spatial subparts; classifying each block of pixels of an image in the set of images in a category according to the number of times that this block of pixels appears in a spatial subpart; and forming at least one privileged zone from blocks of pixels classified in each second category.

According to one embodiment, the method further comprises: adding to the spatial subparts defined according to the points of view at least one predefined spatial subpart, or one that is defined from statistics on points of view of users on said immersive video during other viewings of the immersive video.

According to one embodiment, the method further comprises: associating, with each spatial subpart defined according to a point of view, referred to as the current spatial subpart, a spatial subpart referred to as the extrapolated spatial subpart, defined according to a position of the current spatial subpart and according to information representing a movement of a head of the user corresponding to this point of view, the current and extrapolated spatial subparts being taken into account in the definition of each privileged zone.

According to a second aspect of the invention, the invention relates to a network unit suitable for implementing the method according to the first aspect.

According to a third aspect of the invention, the invention relates to a system comprising at least one item of viewing equipment enabling a plurality of users to simultaneously view an immersive video and a network unit according to the second aspect.

According to a fourth aspect, the invention relates to a computer program comprising instructions for the implementation, by a device, of the method according to the first aspect, when said program is executed by a processor of said device.

According to a fifth aspect, the invention relates to storage means storing a computer program comprising instructions for the implementation, by a device, of the method according to the first aspect, when said program is executed by a processor of said device.

The features of the invention mentioned above, as well as others, will emerge more clearly from a reading of the following description of an example embodiment, said description being given in relation to the accompanying drawings, among which:

FIG. 1 illustrates schematically an example of a system for broadcasting immersive videos;

FIG. 2 illustrates schematically spatial subparts of an immersive video seen by a plurality of users;

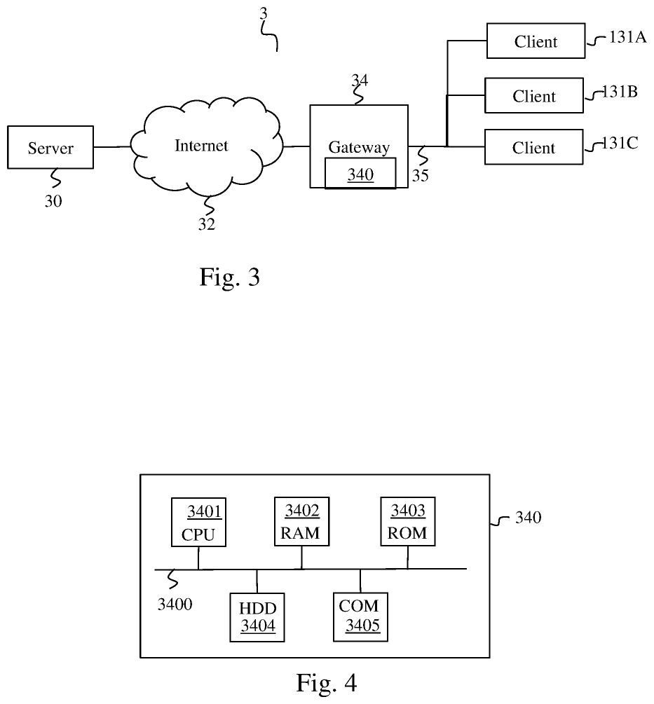

FIG. 3 illustrates schematically a system in which the invention is implemented;

FIG. 4 illustrates schematically an example of hardware architecture of a residential gateway according to the invention;

FIG. 5 illustrates schematically a method for adapting an immersive video to a set of points of view of users;

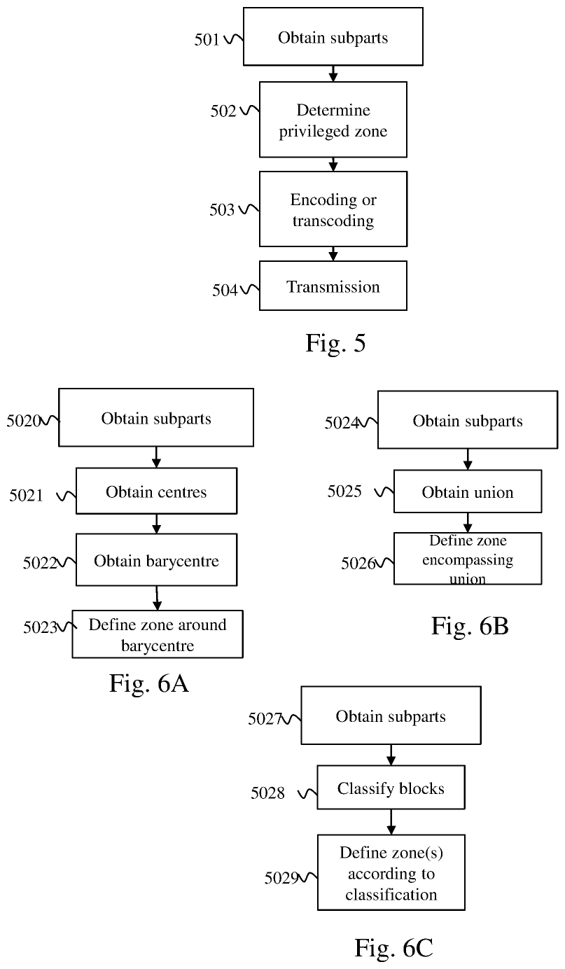

FIGS. 6A, 6B and 6C illustrate schematically three examples of a method for defining at least one image zone, referred to as the privileged zone, in which the blocks of pixels must on average have a lower compression rate than blocks of pixels not belonging to a privileged zone;

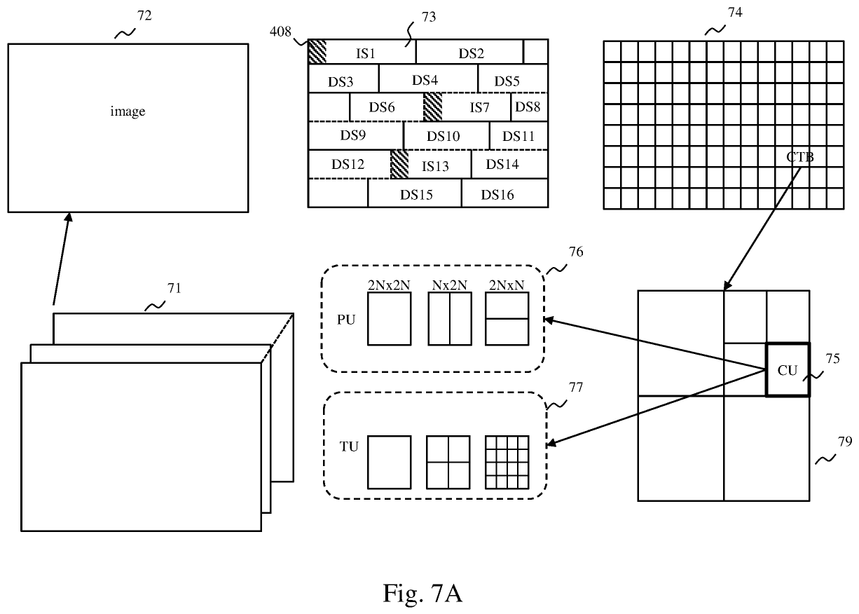

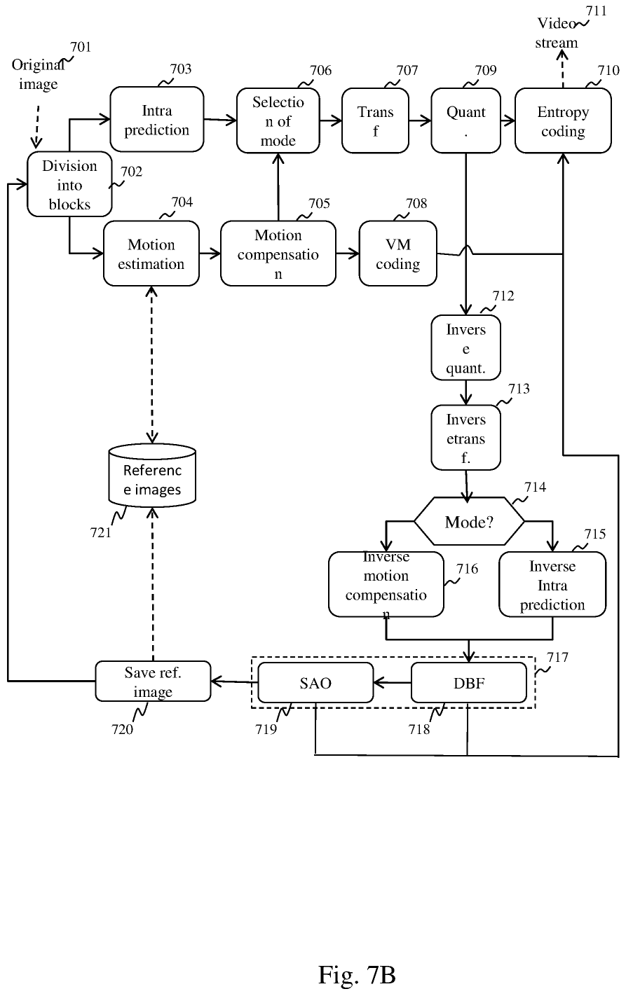

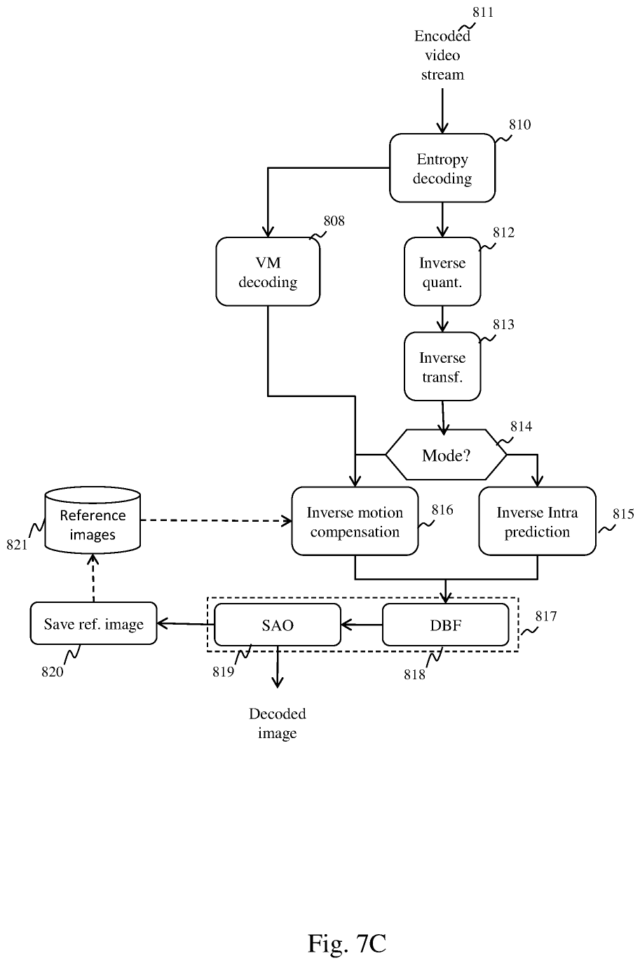

FIG. 7A illustrates schematically the successive partitionings undergone by a video image during an HEVC encoding;

FIG. 7B depicts schematically a method for encoding a video stream compatible with the HEVC standard;

FIG. 7C depicts schematically a decoding method according to the HEVC standard

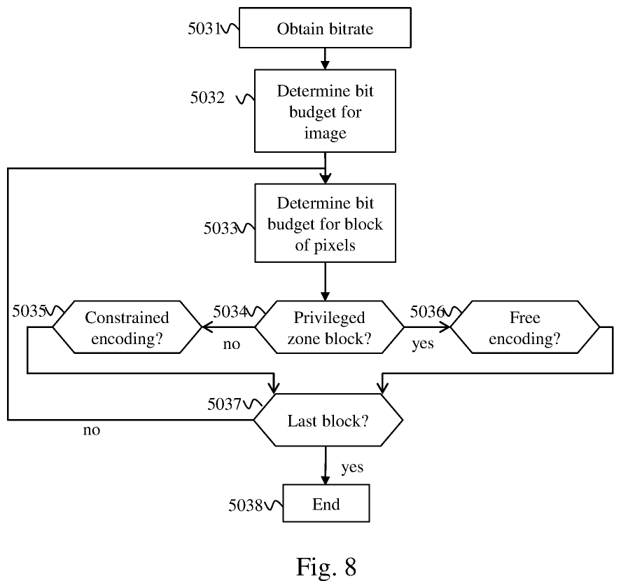

FIG. 8 depicts schematically an adaptation method intended to adapt a non-encoded video; and

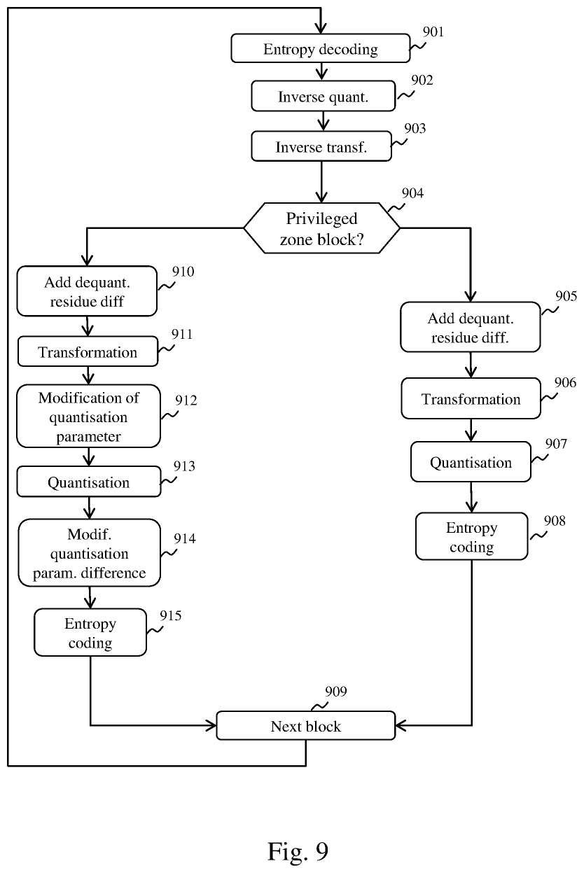

FIG. 9 depicts schematically an adaptation method intended to adapt an encoded video.

Hereinafter, the invention is described in the context of a plurality of users each using an item of viewing equipment such as immersive glasses comprising a processing module. Each user views the same immersive video, but potentially from different points of view. Each user can move away from or closer to the immersive video, turn around, turn his head, raise his head, etc. All these movements change the point of view of the user. The invention is however suited to other viewing equipment such as viewing equipment comprising a room dedicated to the broadcasting of immersive videos equipped with a 360 degree screen or a screen in dome form or a plurality of image projection devices each projecting part of an immersive video. Each image projection device is then connected to an external processing module. The users can then move in the room and look at the immersive video from different points of view.

FIG. 3 illustrates schematically a system 3 in which the invention is implemented.

The system 3 comprises a server 30 connected by a wide area network (WAN) 32 such as an internet to a residential gateway 34, simply referred to as a gateway hereinafter, situated for example in a dwelling. The gateway 34 makes it possible to connect a local area network (LAN) 35 to the wide area network 32. The local network 35 is for example a wireless network such as a Wi-Fi network (ISO/IEC 8802-11). In FIG. 3, a plurality of identical clients 131A, 131B and 131C, each included in a pair of immersive glasses, are connected to the gateway by the local network 35. Each pair of immersive glasses is worn by a user, who can walk about in the dwelling in order to obtain different points of view on the immersive video. Moreover, each pair of immersive glasses comprises a positioning module suitable for determining information representing the point of view of the user on the immersive video.

The server 30 stores the immersive video in full spatial and temporal resolution in the form of a binary video stream that is non-compressed or is compressed according to a video compression standard such as the MPEG-4 Visual video compression standard (ISO/IEC 14496-2), the standard H.264/MPEG-4 AVC (ISO/IEC 14496-10—MPEG-4 Part 10, Advanced Video Coding/ITU-T H.264) or the standard H.265/MPEG-4 HEVC (ISO/IEC 23008-2—MPEG-H Part 2, High Efficiency Video Coding/ITU-T H.265). The immersive video is composed of a series of images, each image being composed of blocks of pixels.

The server 30 is suitable for broadcasting the immersive video to the gateway 34. The gateway 34 comprises an adaptation module 340 capable of adapting the immersive video to points of view of a set of users so as to satisfy a maximum number of users.

It should be noted that the method could just as well function without a server. In this case, it is the gateway that stores the immersive video in addition to being responsible for adapting it and transmitting it to the clients 131A, 131B and 131C.

FIG. 2 illustrates schematically spatial subparts of an immersive video seen by a plurality of users.

In FIG. 2, the immersive video 10 can be seen applied to a ring in FIG. 1. However, in FIG. 2, the ring has been unfolded so that the video appears in a plane. It is assumed that in FIG. 2 the three users are viewing different points of view. The user using the immersive glasses comprising the processing module 131A is viewing the subpart 11A. The user using the immersive glasses comprising the processing module 131B is viewing the zone 11B. The user using the immersive glasses comprising the processing module 131C is viewing the zone 11C. The user using the immersive glasses comprising the processing module 131A has a point of view further away on the video than the other two users, which explains the fact that the subpart 11A is larger than the subparts 11C and 11B. The user using the immersive glasses comprising the processing module 131C is oriented on the immersive video further to the left than the user using the immersive glasses comprising the processing module 131B.

FIG. 4 illustrates schematically an example of hardware architecture of the adaption module 340. The adaptation module 340 then comprises, connected by a communication bus 3400: a processor or CPU (central processing unit) 3401; a random access memory RAM 3402; a read only memory ROM 3403; a storage unit or a storage medium reader such as an SD (secure digital) card reader 3404; a set of communication interfaces 3405 enabling the adaptation module 340 to communicate with the server 30 through the wide area network 32 and with each client 131 through the local network 35.

The processor 3401 is capable of executing instructions loaded in the RAM 3402 from the ROM 3403, from an external memory (not shown), from a storage medium such as an SD card, or from a communication network. When the adaptation module 340 is powered up, the processor 3401 is capable of reading instructions from the RAM 3402 and executing them. These instructions form a computer program causing the implementation, by the processor 3401, of the method described in relation to FIGS. 5.

All or part of the method described in relation to FIG. 5 can be implemented in software form by the execution of a set of instructions by a programmable machine, such as a DSP (digital signal processor) or a microcontroller, or be implemented in hardware form by a machine or a dedicated component, such as an FPGA (field-programmable gate array) or an ASIC (application-specific integrated circuit).

FIG. 5 illustrates schematically a method for adapting an immersive video to a set of points of view of users making it possible best to satisfy a maximum number of users.

The method described in relation to FIG. 5 is executed by the adaptation module 341 of the gateway 34. However, this method could just as well be implemented by an adaptation module 341 independent of the gateway 34 and situated between the gateway 34 and each client 131A, 131B or 131C. In another embodiment, the adaptation module could also be included in a node of the network situated between the server 30 and the gateway 34 such as a DSLAM (digital subscriber line access multiplexer).

One role of the adaptation module 340 is to adapt the immersive video so that it satisfies a maximum number of users in terms of display quality and in terms of reactivity in the case of a change in point of view.

The method described in relation to FIG. 5 is implemented at regular intervals, for example with a period P corresponding to a duration of an image or of a series of a few images. For example P=34 ms for an immersive video with 30 images per second or P=17 ms for an immersive video with 60 images per second. Thus the adaptation module can adapt each image of the immersive video so as to satisfy a majority of users.

In a step 501, the adaptation module 340 obtains from the client 131A (and respectively 131B and 131C) information representing a point of view observed by the user corresponding to said client. For example, each item of information representing a point of view comprises an azimuth, an angle of elevation and a distance.

In a step 502, the adaptation module 340 determines at least one image zone, referred to as the privileged zone, corresponding to at least some of the points of view. We detail hereinafter in relation to FIGS. 6A, 6B and 6C various methods for determining at least one privileged zone.

In a step 503, for each image following the determination of at least one privileged zone, the adaptation module 340 applies, to the blocks of pixels not belonging to a privileged zone, during an encoding or transcoding, a compression rate on average higher than a mean of the compression rates applied to the blocks of pixels belonging to a privileged zone. Step 503 makes it possible to obtain a video stream corresponding to the immersive video adapted to the points of view of the users. Each image of this immersive video has a higher quality in at least one zone watched by a majority of users and a lower quality in the rest of the image. We detail hereinafter various embodiments of this step.

In one embodiment, the mean of the compression rates of the blocks of pixels of the privileged zones and the mean of the compression rates of the blocks not belonging to a privileged zone depends on a bitrate available on the network 35.

In a step 504, the video stream thus obtained is transmitted to each item of viewing equipment using the local network 35.

In another embodiment, the method is implemented following a change in points of view of a majority of users.

FIGS. 6A, 6B and 6C illustrate schematically three examples of a method for defining at least one image zone, referred to as the privileged zone, in which the blocks of pixels must have on average a lower compression rate than blocks of pixels not belonging to a privileged zone. The blocks of pixels belonging to a privileged zone will therefore have on average a quality higher than the blocks of pixels not belonging to a privileged zone. In this way, the zones of the images of the immersive video that are seen by the users or at least seen by a majority of users are privileged. The methods described in relation to FIGS. 6A, 6B and 6C correspond to step 502.

The method described in relation to FIG. 6A begins with a step 5020. During step 5020, from each item of information representing a point of view, the adaptation module 340 determines a spatial subpart of the immersive video corresponding to said point of view. Each spatial subpart is for example a rectangle aligned on boundaries of blocks of pixels.

In a step 5021, the adaptation module 340 determines a centre for each spatial subpart.

In a step 5022, the adaptation module 340 determines a barycentre of the centres of the spatial subparts, that is to say a point that minimises a sum of the distances between said point and each centre. In one embodiment, the barycentre is a point minimising a distance to a predefined percentage of centres. The predefined percentage is for example 80%.

In a step 5023, the adaptation module 340 defines a rectangular zone centred on the barycentre, said rectangular zone forming a privileged zone. In one embodiment, the rectangular zone has predefined dimensions. In one embodiment, the rectangular zone has dimensions equal to a mean of the dimensions of the spatial subparts. In one embodiment, the adaptation module determines the dimensions of the rectangular zone according to a bitrate available on the network 35. When said bitrate is low, below a first bitrate threshold, the dimensions of the rectangular zone are equal to predefined mean dimensions of a spatial subpart, which makes it possible to fix minimum dimensions for the rectangular zone. When said bitrate is high, above a second bitrate threshold, the dimensions of the rectangular zone are equal for example to twice the predefined mean dimensions of a spatial subpart, which makes it possible to fix maximum dimensions of the rectangular zone. When said bitrate is average, between the first and second bitrate thresholds, the dimensions of the rectangular zone increase linearly according to the bitrate between the predefined mean dimensions of a spatial subpart and twice the predefined mean dimensions of a spatial subpart. In this embodiment, a zone actually seen by the users is therefore privileged. However, when the bitrate so permits, the privileged zone is extended so as to enable a user changing point of view to have a display of the immersive video of good quality despite this change. In one embodiment, the first and second bitrate thresholds are equal.

The method described in relation to FIG. 6B begins with a step 5024 identical to step 5020.

In a step 5025, the adaptation module 340 determines a union of the spatial subparts. A union is formed only for the spatial subparts that overlap. Thus it is possible to obtain a plurality of groups of spatial subparts resulting from a union of overlapping spatial subparts.

In a step 5026, for each group of spatial subparts formed by union, the adaptation module defines a rectangular zone encompassing said group of spatial subparts. Each rectangular zone then forms a privileged zone. In one embodiment, the groups of spatial subparts comprising few spatial subparts, for example comprising a number of spatial subparts below a predetermined number, are not taken into account for defining a privileged zone.

The method described in relation to FIG. 6C begins with a step 5027 identical to step 5020.

In a step 5028, each block of pixels of an image is classified in a category according to the number of times that this block of pixels appears in a spatial subpart. It is thus possible to form a plurality of categories of pixel blocks. A first category is for example a category of pixel blocks not appearing in a spatial subpart. A second category comprises pixel blocks appearing at least N times in a spatial subpart. N is an integer number equal for example to 5. A third category comprises pixel blocks appearing neither in the first nor in the second category. The adaptation module 340 in a step 5029 forms a first privileged zone from blocks of pixels belonging to the second category and a second privileged zone from blocks of pixels belonging to the third category. In one embodiment, following the implementation of the method described in relation to FIG. 6C, the privileged zones the dimensions of which are less than the mean dimensions of a spatial subpart are eliminated. The blocks of pixels belonging to these eliminated zones are considered not to form part of a privileged zone.

In one embodiment, in steps 5020, 5024 and 5027, there is added to the spatial subparts corresponding to the points of view of the users at least one spatial subpart that is predefined, for example by a producer of the immersive video, or defined from statistics on points of view of users on said immersive video during other viewings of the immersive video.

In one embodiment, in steps 5020, 5024 and 5027, each spatial subpart corresponding to a point of view of a user, referred to as the current spatial subpart, is associated with a second spatial subpart obtained by taking into account a movement of the head of the user, referred to as the extrapolated spatial subpart. It is assumed that the immersive glasses of the user comprise a motion-measuring module. The client 131 obtains motion information from the motion-measuring module and transmits this information to the adaptation module 340. The motion information is for example a motion vector. From the motion information and from a position of the current spatial subpart, the adaptation module determines a position of the extrapolated spatial subpart. The whole formed by the current spatial subparts and the extrapolated spatial subparts is next used in the remainder of the methods described in relation to FIGS. 6A, 6B and 6C.

In one embodiment, in step 503, each image of the immersive video considered during the period P is compressed in accordance with a video compression standard or transcoded so that it is compatible with the video compression standard. In one embodiment, the video compression standard used is HEVC.

FIGS. 7A, 7B and 7C describe an example of implementation of the HEVC standard.

FIG. 7A illustrates the successive partitionings undergone by an image of pixels 72 of an original video 71, during the encoding thereof in accordance with the HEVC standard. It is considered here that a pixel is composed of three components: a luminance component and two chrominance components. In the example in FIG. 7A, the image 72 is initially divided into three slices. A slice is a zone of the image that may cover the whole of the image or only a portion, such as the slice 73 in FIG. 7A. A slice comprises at least one slice segment optionally followed by other slice segments. The slice segment in the first position in the slice is referred to as the independent slice segment. An independent slice segment, such as the slice segment IS1 in the slice 73, comprises a complete header, such as a header 78. The header 78 comprises a set of syntax elements enabling the slice to be decoded. Any other slice segments of a slice, such as slice segments DS2, DS3, DS4, DS5 and DS6 of the slice 73 in FIG. 7A, are referred to as dependent slice segments since they have only a partial header referring to the independent slice segment header that precedes them in the slice, here the header 78. It should be noted that, in the AVC standard, only the concept of slice exists, a slice necessarily comprising a complete header and not being able to be divided.

It should be noted that each slice of an image can be decoded independently of any other slice of the same image. However, the use of a loop post-filtering in a slice may necessitate the use of data of another slice. After the partitioning of the image 72 in slices, the pixels of each slice of an image are partitioned into coding tree blocks (CTBs), such as a set of coding tree blocks 72 in FIG. 7A. Hereinafter, in order to simplify, we shall use the acronym CTB to designate a coding tree block. A CTB, such as the CTB 79 in FIG. 7A, is a square block of pixels the size of which is equal to a power of two and the size of which may range from 16 to 64 pixels. A CTB may be partitioned in the form of a quadtree in one or more coding units (CUs). A coding unit is a square block of pixels the size of which is equal to a power of two and the size of which may range from 8 to 64 pixels. A coding unit, such as the coding unit 405 in FIG. 4, may then be partitioned into prediction units (PUs) used in spatial or temporal predictions and in transform units (TUs) used in the transformations of blocks of pixels in the frequency domain.

During the coding of an image, the partitioning is adaptive, that is to say each CTB is partitioned so as to optimise the compression performances of the CTB. Hereinafter, in order to simplify, we shall consider that each CTB is partitioned into a coding unit and that this coding unit is partitioned into a transform unit and a prediction unit. In addition, all the CTBs have the same size. The CTBs correspond to the block of pixels described in relation to FIGS. 3, 5, 6A, 6B and 6C.

It is also assumed hereinafter that each encoded image comprises only one independent slice.

FIG. 7B depicts schematically a method for encoding a video stream compatible with the HEVC standard used by the coding module. The encoding of a current image 701 of an image begins with a partitioning of the current image 701 during a step 702, as described in relation to FIG. 7A. For simplification, in the remainder of the description of FIG. 7B and in the description of FIG. 7C, we do not differentiate the CTBs, coding units, transform units and prediction units and we group these four entities under the term block of pixels. The current image 701 is thus partitioned into blocks of pixels. For each block of pixels the encoding device must determine a coding mode between an intra-image coding mode, referred to as the INTRA coding mode, and an inter-image coding mode, referred to as the INTER coding mode.

The INTRA coding mode consists of predicting, in accordance with an INTRA prediction method, in a step 703, the pixels of a current block of pixels from a prediction block derived from pixels of reconstructed blocks of pixels situated in a causal vicinity of the block of pixels to be encoded. The result of the INTRA prediction is a prediction direction indicating which pixels of the blocks of pixels in the vicinity to use, and a residual block resulting from a calculation of a difference between the current block of pixels and the prediction block.

The INTER coding mode consists of predicting the pixels of a current block of pixels from a block of pixels, referred to as the reference block, of an image preceding or following the current image, this image being referred to as the reference image. During the encoding of a current block of pixels in accordance with the INTER coding mode, the block of pixels of the reference image that is closest, in accordance with a similarity criterion, to the current block of pixels is determined by a motion estimation step 704. In step 704, a motion vector indicating the position of the reference block of pixels in the reference image is determined. Said motion vector is used during a motion compensation step 705 during which a residual block is calculated in the form of a difference between the current block of pixels and the reference block. It should be noted that we have described here a mono-predicted INTER coding mode. There also exists a bi-predicted INTER coding mode (or B mode) in which a current block of pixels is associated with two motion vectors, designating two reference blocks in two different images, the residual block of this block of pixels then being an average of the two residual blocks.

In a selection step 706, the coding mode optimising the compression performances, in accordance with a bitrate/distortion criterion, among the two modes tested is selected by the encoding device. When the coding mode is selected, the residual block is transformed in a step 707 and quantised in a step 708. When the current block of pixels is encoded in accordance with the INTRA coding mode, the prediction direction and the transformed and quantised residual block are encoded by an entropy encoder during a step 510. When the current block of pixels is encoded according to the INTER coding mode, the motion vector of the block of pixels is predicted using a prediction vector selected from a set of motion vectors corresponding to reconstructed blocks of pixels situated in the vicinity of the block of pixels to be encoded. The motion vector is next encoded by the entropy encoder during step 710 in the form of a motion residual and an index for identifying the prediction vector. The transformed and quantised residual block is encoded by the entropy encoder during step 710. The result of the entropy encoding is inserted in a binary video stream 711.

In the HEVC standard, the parameter for quantisation of a block of pixels is predicted from parameters for quantisation of blocks of pixels of the vicinity or from a quantisation parameter described in the slice header. Syntax elements then encode, in the binary stream of the video, a difference between the parameter for quantisation of a block of pixels and the prediction thereof (cf. section 7.4.9.10 and section 8.6 of the HEVC standard).

After quantisation in step 709, the current block of pixels is reconstructed so that the pixels that said current block of pixels contains can serve for future predictions. This reconstruction phase is also referred to as a prediction loop. An inverse quantisation in a step 712 and an inverse transformation in a step 713 are therefore applied to the transformed and quantised residual block. According to the coding mode used for the block of pixels obtained in a step 714, the prediction block of the block of pixels is reconstructed. If the current block of pixels is encoded according to the INTER coding mode, the encoding device, in a step 716, applies an inverse motion compensation using the motion vector of the current block of pixels in order to identify the reference block of the current block of pixels. If the current block of pixels is encoded in accordance with an INTRA coding mode, in a step 715, the prediction direction corresponding to the current block of pixels is used for reconstructing the reference block of the current block of pixels. The reference block and the reconstructed residual block are added in order to obtain the reconstructed current block of pixels.

Following the reconstruction, a loop post-filtering is applied, in a step 717, to the reconstructed block of pixels. This post-filtering is called loop post-filtering since this post-filtering takes place in the prediction loop so as to obtain, on encoding, the same reference images as the decoding and thus avoid any offset between encoding and decoding. HEVC loop post-filtering comprises two post-filtering methods, i.e. deblocking filtering and SAO (sample adaptive offset) filtering. It should be noted that the post-filtering of H.264/AVC comprises only deblocking filtering.

The purpose of deblocking filtering is to attenuate any discontinuities at boundaries of blocks of pixels due to the differences in quantisation between blocks of pixels. It is an adaptive filtering that can be activated or deactivated and, when it is activated, can take the form of high-complexity deblocking filtering based on a separable filter with a dimension comprising six filter coefficients, which is hereinafter referred to as strong filter, and low-complexity deblocking filtering based on a separable filter with a dimension comprising four coefficients, which is hereinafter referred to as weak filter. The strong filter greatly attenuates any discontinuities at the boundaries of the blocks of pixels, which may damage spatial high frequencies present in original images. The weak filter weakly attenuates any discontinuities at the boundaries of the blocks of pixels, which makes it possible to preserve spatial high frequencies present in the original images, but will be less effective on any discontinuities artificially created by quantisation. The decision to filter or not to filter, and the form of the filter used in the case of filtering, are dependent on the value of the pixels at the boundaries of the block of pixels to be filtered and two parameters encoded in the binary video stream in the form of two syntax elements defined by the HEVC standard. A decoding device can, using these syntax elements, determine whether a deblocking filtering must be applied and the form of deblocking filtering to be applied.

SAO filtering takes two forms having two different objectives. The purpose of the first form, referred to as edge offset, is to compensate for the effects of the quantisation on the contours in the blocks of pixels. Edge offset SAO filtering comprises a classification of the pixels of the reconstructed image according to four categories corresponding to four respective types of contour. A pixel is classified by filtering according to four filters, each filter making it possible to obtain a filtering gradient. The filtering gradient maximising a classification criterion indicates the type of contour corresponding to the pixel. Each type of contour is associated with an offset value that is added to the pixels during SAO filtering.

The second form of SAO is referred to as band offset and the purpose thereof is to compensate for the effect of the quantisation on pixels belonging to certain ranges (i.e. bands) of values. In band offset filtering, all the possible values for a pixel, most frequently lying between 0 and 255 for 8-bit video streams, are divided into 32 ranges of eight values. Among these 32 ranges, four consecutive ranges are selected to be offset. When a pixel has a value lying in one of the four ranges of values to be offset, an offset value is added to the value of the pixel.

The decision to implement SAO filtering, and when SAO filtering is implemented, the form of the SAO filtering and the offset values are determined for each CTB by the encoding device via bitrate/distortion optimisation. In the entropy encoding step 510, the encoding device inserts information in the binary video stream 511 enabling a decoding device to determine whether SAO filtering is to be applied to a CTB and, where applicable, the form and the SAO filtering parameters to be applied.

When a block of pixels is reconstructed, it is inserted in a step 520 into a reconstructed image stored in the reconstructed-image memory 521, also referred to as the reference image memory. The reconstructed images thus stored can then serve as reference images for other images to be encoded.

When all the blocks of pixels in a slice are encoded, the binary video stream corresponding to the slice is inserted in a container referred to as a Network Abstraction Layer Unit (NALU). In the case of network transmission, these containers are inserted in network packets either directly or in intermediate transport stream containers, such as the MP4 transport streams.

FIG. 7C depicts schematically a method for decoding a stream compressed according to the HEVC standard implemented by a decoding device. The decoding takes place block of pixels by block of pixels. For a current block of pixels, it commences with an entropy decoding of the current block of pixels during a step 810. Entropy decoding makes it possible to obtain the coding mode for the block of pixels.

If the block of pixels has been encoded in accordance with the INTER coding mode, entropy decoding makes it possible to obtain a prediction vector index, a motion residual and a residual block. In a step 808, a motion vector is reconstructed for the current block of pixels using the prediction vector index and the motion residual.

If the block of pixels has been encoded according to the INTRA coding mode, entropy decoding makes it possible to obtain a prediction direction and a residual block. Steps 812, 813, 814, 815 and 816 implemented by the decoding device are in all aspects identical respectively to steps 812, 813, 814, 815 and 816 implemented by the encoding device.

The decoding device next applies a loop post-filtering in a step 817. As with encoding, loop post-filtering comprises, for the HEVC standard, a deblocking filtering and an SAO filtering, while loop filtering comprises only a deblocking filtering for the AVC standard.

The SAO filtering is implemented by the decoding device in a step 819. During decoding, the decoding device does not have to determine whether SAO filtering must be applied to a block of pixels and, if SAO filtering must be applied, the decoding device does not have to determine the form of SAO filtering to be applied and the offset values, since the decoding device will find this information in the binary video stream. If, for a CTB, the SAO filtering is of the edge offset type, for each pixel of the CTB the decoding device must determine by filtering the type of contour and add the offset value corresponding to the type of contour determined. If for a CTB the SAO filtering is of the band offset type, for each pixel of the CTB the decoding device compares the value of the pixel to be filtered with ranges of values to be offset and, if the value of the pixel belongs to one of the ranges of values to be offset, the offset value corresponding to said range of values is added to the value of the pixel.

As seen above in relation to FIG. 5, in step 503 the adaptation module 340 applies, to the blocks of pixels not belonging to a privileged zone, a compression rate on average higher than a mean of the compression rates applied to the blocks of pixels belonging to a privileged zone. The compression rate of a block of pixels greatly depends firstly on its coding mode and secondly on its quantisation parameter.

When the adaptation module receives a non-encoded immersive video it must encode each image of the immersive video applying different compression rates depending on whether or not the blocks of pixels belong to a privileged zone.

FIG. 8 depicts schematically an adaptation method intended to adapt a non-encoded video implemented by the adaptation module in step 503.

In a step 5031, the adaptation module obtains information representing a bitrate available on the local network 35.

In a step 5032, the adaptation module determines, from the information representing a bitrate, a bit budget for an image to be encoded.

In a step 5033, the adaptation module determines, from said budget, a bit budget for each block of pixels of the image to be encoded. For the first block of pixels of the image to be encoded, the bit budget of a block of pixels is equal to the budget for the image to be encoded divided by the number of blocks of pixels of the image to be encoded. For the other blocks of pixels of the image, the bit budget for a block of pixels is equal to the bit budget for the image to be encoded from which there are subtracted the bits already consumed for the blocks of pixels encoded previously divided by the number of blocks of pixels of the image to be encoded remaining to be encoded.

In a step 5034, the adaptation module determines whether the current block of pixels to be encoded is a block of pixels belonging to a privileged zone. If such is the case, the adaptation module applies, to the current block of pixels, the method described in relation to FIG. 7B in a step 5036. Bitrate/distortion optimisation makes it possible to determine the coding mode and the quantisation parameter of the current block of pixels.

If the current block of pixels does not belong to a privileged zone, the adaptation module also applies, to the current block of pixels, the method described in relation to FIG. 7B. However, in step 5035, the adaptation module adds a predefined constant A to the value of the quantisation parameter determined by the bitrate/distortion optimisation. In one embodiment the predefined constant A =3.

Following steps 5035 and 5036, the adaptation module determines, in a step 5037, whether the current block of pixels is the last block of pixels of the image to be encoded. If such is not the case, the adaptation module returns to step 5033 in order to carry out the encoding of a new block of pixels. If it is the last block of pixels of the image to be encoded, the method described in relation to FIG. 8 ends and the adaptation module returns to step 501 or starts encoding of a new image.

By allocating, to the blocks of pixels not belonging to a privileged zone, a quantisation parameter higher than the quantisation parameter determined by the bitrate/distortion optimisation, a larger proportion of the bitrate budget of an image is left to the blocks of pixels belonging to a privileged zone. In this way, the quality of a privileged zone is better than the quality of a non-privileged zone.

It should be noted that the method of FIG. 8 is applicable to other video compression standards, such as AVC or MPEG-4 Visual. However, in the context of MPEG-4 Visual, the quantisation parameter of a block of pixels is predicted from the quantisation parameter of the last encoded block of pixels in an image but the difference in absolute value between a quantisation parameter and its predictor does not exceed 2. In this case, a transition between a privileged zone and a non-privileged zone (and vice versa) must take place over several blocks of pixels if the predefined constant A is greater than 2.

In one embodiment, rather than artificially increasing the quantisation parameter of each block of pixels not situated in a privileged zone using the predefined constant Δ, the bit budget for an image to be encoded is divided into two separate sub-budgets: a first sub-budget for the blocks of pixels belonging to a privileged zone and a second sub-budget for the blocks of pixels not belonging to a privileged zone. The first sub-budget is larger than the second sub-budget. For example, the first sub-budget is equal to two thirds of the bit budget for an image, whereas the second budget is equal to one third of the bit budget for an image.

When the immersive video is a video encoded according to a video compression standard, the adaptation of the immersive video by the adaptation module 340 may consist of a transcoding.

In one embodiment, during the transcoding, the adaptation module 340 fully decodes each image of the immersive video in question during the period P, for example in accordance with the method described in relation to FIG. 7C, and re-encodes it in accordance with the method described in relation to FIG. 8.

In one embodiment, during the transcoding, the adaptation module only partially decodes and re-encodes the encoded immersive video so as to reduce the complexity of the transcoding. It is assumed here that the immersive video was encoded in the HEVC format.

FIG. 9 depicts schematically an adaptation method intended to adapt an encoded video implemented by the adaptation module in step 503.

The method described in relation to FIG. 9 is implemented for each image of the immersive video in question during the period P block of pixels by block of pixels.

In a step 901, the adaptation module 340 applies an entropy decoding to the current block of pixels as described in step 810.

In a step 902, the adaptation module 340 applies an inverse quantisation to the current block of pixels, as described in step 812.

In a step 903, the adaptation module 340 applies an inverse transformation to the current block of pixels as described in step 813. At this stage a residual prediction block is obtained.

In a step 904, the adaptation module 340 determines whether the current block of pixels belongs to a privileged zone.

If the current block of pixels belongs to a privileged zone, the adaptation module 340 executes a step 905. During step 905, the fact that the reference block or blocks (either reference blocks for INTRA prediction or reference blocks for INTER prediction) of the current block of pixels have been able to be requantised is taken into account. In the case of requantisation, a reference block is therefore different from the original reference block. INTER or INTRA prediction using this modified reference block is therefore incorrect. Therefore, in step 905, a requantisation error is added to the residual block reconstructed from the current block of pixels in order to compensate for the requantisation effect.

A requantisation error is a difference between a residual block reconstructed before requantisation and the same residual block reconstructed after a requantisation has been taken into account. There may be a direct requantisation error following requantisation of a residual block and an indirect requantisation error following requantisation of at least one reference block of a block of pixels predicted by INTRA or INTER prediction. In the method described in relation to FIG. 9, whenever a residual block of a current block of pixels is reconstructed, the adaptation module 340 calculates a difference between the original residual block of the reconstructed current block of pixels and the residual block of the current block of pixels reconstructed while taking into account a direct and/or indirect requantisation error affecting this residual block. This difference forms the requantisation error in the current block of pixels. The requantisation error of each block of pixels is preserved by the adaptation module 340, for example in the form of a requantisation error image, in order to be able to be used for calculating the requantisation error in other blocks of pixels referring to the current block of pixels (i.e. in step 905).

In a step 906, the adaptation module 340 applies a transformation as described in step 707 to the residual block obtained in step 905.

In a step 907, the adaptation module 340 applies a quantisation as described in step 709 to the transformed residual block obtained in step 906, reusing the original quantisation parameter of said current block of pixels.

In a step 908, the adaptation module 340 applies an entropy coding as described in step 710 to the quantised residual block obtained in step 907 and inserts a binary stream corresponding to said entropy coding in the binary stream of the immersive video in replacement for the original binary stream corresponding to the current block of pixels.

In a step 909, the adaptation module 340 passes to a following block of pixels of the current image, or passes to another image if the current block of pixels is the last block of pixels of the current image.

When the current block of pixels does not belong to a privileged zone, this block of pixels is requantised with a higher quantisation parameter than its original quantisation parameter.

The adaptation module 340 performs steps 910 and 911, which are respectively identical to steps 905 and 906.

In a step 912, the adaptation module 340 modifies the quantisation parameter of the current block of pixels. The adaptation module then adds a predefined constant A to the value of the quantisation parameter of the current block of pixels.

In a step 913, the adaptation module 340 applies a quantisation as described in step 709 to the transformed residual block obtained in step 911, using the modified quantisation parameter of the current block of pixels.

We have seen in relation to FIG. 7B that, in the HEVC standard, the quantisation parameter of a block of pixels is predicted from quantisation parameters of blocks of pixels in the vicinity thereof. Syntax elements next code, in the binary stream of the video, a difference between the quantisation parameter of a block of pixels and the prediction thereof. When the quantisation parameter of a current block of pixels is modified, it is necessary to compensate for this modification in the adjacent blocks of pixels the quantisation parameter of which is predicted from the quantisation parameter of the current block of pixels.

In a step 914, the adaptation module 340 modifies, in the binary stream of the video, each syntax element representing a difference between a quantisation parameter of a block of pixels and the prediction thereof for each block of pixels the quantisation parameter of which is predicted from the quantisation parameter of the current block of pixels to be taken. The adaptation module 340 thus adds a value to the value of each syntax element representing a difference between a quantisation parameter of a block of pixels and the prediction thereof in order to compensate for the modification of the prediction due to the modification of a quantisation parameter.

In a step 915, the adaptation module proceeds with the entropy coding of the residual block obtained in step 913 and of each syntax element obtained in step 914 and inserts a binary stream corresponding to said entropy coding in the binary stream of the immersive video in replacement for the original binary stream corresponding to the current block of pixels.

In one embodiment, in the method of FIG. 9, the predefined constant A is fixed so that the transcoded immersive video is compatible with a bitrate constraint on the local network 35.

In one embodiment, in the method of FIG. 9, the quantisation parameters of the blocks of pixels belonging to a privileged zone are also increased by a predefined constant Δ′ so that the transcoded immersive video is compatible with a bitrate constraint on the local network 35. However Δ′<Δ.

1. A method for transmitting an immersive video between a network unit and at least one item of viewing equipment enabling a plurality of users to view said immersive video simultaneously, the network unit and each item of viewing equipment being connected by a communication network, the immersive video comprising a series of sets of images, each set consisting of successive images, each image being composed of blocks of pixels, the immersive video being transmitted in encoded form according to a predetermined video compression standard to each item of viewing equipment, wherein the method is implemented by the network unit and comprises, for each set of images:
obtaining information representing a point of view on the immersive video observed by each user;
determining at least one image zone, referred to as the privileged zone, corresponding to at least some of the points of view, the determination comprising:
determining, for each point of view, a spatial subpart of the immersive video corresponding to said point of view;
defining a plurality of categories of blocks of pixels, a first category comprising blocks of pixels not appearing in any spatial subpart, and at least one second category comprising blocks of pixels appearing at least in a predefined number of spatial subparts;
classifying each block of pixels of an image in the set of images in a category according to the number of times that this block of pixels appears in a spatial subpart; and
forming at least one privileged zone from blocks of pixels classified in each second category. for each image included in the set of images, applying to the blocks of pixels not belonging to a privileged zone a compression rate on average higher than a mean of the compression rates applied to the blocks of pixels belonging to a privileged zone, and
transmitting the set of images to each item of viewing equipment.

2. The method according to claim 1, wherein the network unit obtains the immersive video in a non-compressed form and encodes the immersive video according to the predetermined video compression standard, or the network unit obtains the immersive video in a compressed form and transcodes the immersive video so that it is compatible with the predetermined video compression standard.

3. The method according to claim 1, wherein it further comprises: adding to the spatial subparts defined according to a point of view at least one predefined spatial subpart, or one that is defined from statistics on points of view of users on said immersive video during other viewings of the immersive video.

4. The method according to claim 1, wherein it further comprises associating, with each spatial subpart defined according to points of view, referred to as the current spatial subpart, a spatial subpart referred to as the extrapolated spatial subpart, defined according to a position of the current spatial subpart and according to information representing a movement of a head of the user corresponding to this point of view, the current and extrapolated spatial subparts being taken into account in the definition of each privileged zone.

5. A network unit suitable for implementing the method according to claim 1.

6. A system comprising at least one item of viewing equipment enabling a plurality of users to simultaneously view an immersive video and a network unit according to claim 5.

7. (canceled)

8. A non transitory storage medium storing a computer program comprising instructions for the implementation, by a device, of the method according to claim 1, when said program is executed by a processor of said device.
